(19) United States
(12) Patent Application Publication
(10) Pub. No.: US 2019/0012535 A1
(43) Pub. Date: Jan. 10, 2019

(54) TRAIL CAMERA IMAGE RECOGNITION SYSTEM

(71) Applicants: Jason Dorr Collins, Grand Rapids, MI (US); Pavllo Andoni, Grand Rapids, MI (US); Brendan Thomas Grimes, Grand Rapids, MI (US); Sachin Rajendra Kushwaha, Grand Rapids, MI (US); Brian Michael Schulte, Grand Rapids, MI (US); Kyle Michael Sullivan, Grand Rapids, MI (US); Howard Adam Paul, Grand Rapids, MI (US); Stacy Ann Paul, Grand Rapids, MI (US)

(72) Inventors: Jason Dorr Collins, Grand Rapids, MI (US); Pavllo Andoni, Grand Rapids, MI (US); Brendan Thomas Grimes, Grand Rapids, MI (US); Sachin Rajendra Kushwaha, Grand Rapids, MI (US); Brian Michael Schulte, Grand Rapids, MI (US); Kyle Michael Sullivan, Grand Rapids, MI (US); Howard Adam Paul, Grand Rapids, MI (US); Stacy Ann Paul, Grand Rapids, MI (US)

(73) Assignee: Trail Camera Solutions, LLC, Grand Rapids, MI (US)

(21) Appl. No.: 16/009,985

(22) Filed: Jun. 15, 2018

Related U.S. Application Data
(60) Provisional application No. 62/519,940, filed on Jun. 15, 2017.

(51) Int. Cl. G06K 9/00; H04N 7/18; G06K 9/62

(52) U.S. Cl. CPC G06K 9/00369; G06K 9/6293; H04N 7/183; G06K 9/00697

(57) ABSTRACT

A trail camera system includes a camera configured to capture image data of a desired location, a database configured to receive image data, and an image processor configured to process the image data. The image processor may be configured to compare the image data from the camera with data related to known animals and determine the likelihood of a match between an animal in the image data and a known animal.

### CROSS-REFERENCE TO RELATED APPLICATION

This application claims priority to U.S. Provisional Patent Application No. 62/519,940 filed on Jun. 15, 2017 and entitled TRAIL CAMERA IMAGE RECOGNITION SYSTEM, which is hereby incorporated by reference

### FIELD OF INVENTION

The present invention generally relates to a system and method for adding image recognition results to image data to provide comparative analysis and more specification to a system for monitoring and tracking animals in a monitored space using image recognition on trail camera image data.

### BACKGROUND

Hunters often have multiple places to hunt, such as numerous tree stands within various destinations or properties. To help determine which location or property is the best for hunting, many hunters employ trail cameras that take pictures of the surrounding areas to help locate local animal populations. Trail cameras may be designed to take pictures at intermittent time intervals or when a combination of heat and movement is sensed or detected. However, several deficiencies exist with current trail camera systems.

First, current trail camera systems fail to provide users with any sophisticated analytics. Instead, current systems merely feed raw image data to users and allow them to use the data as they please without further analyzing for trends, patterns, or groupings that may be useful. Hunters are left to decipher and infer information on their own using manual processes.

Second, as camera technologies have evolved, so have trail cameras. In particular, the move from film to digital cameras that capture digital images has allowed for ease in transferring image data, but has also created a burden on trail camera users to analyze and interpret many images. Today's digital cameras not only are capable of producing more images, they can also append and tag the images with other metadata, such as time, date, location, and other useful information. Processing both the digital images and metadata to find useful information is both difficult and cumbersome.

Accordingly, an improved system and method for tracking, cataloging, and tagging trail camera photos and then subsequently proving the user with insights and a recommendation is needed.

### BRIEF DESCRIPTION OF THE DRAWINGS

The operation of the invention may be better understood by reference to the detailed description taken in connection with the following illustrations, wherein:

FIG. 1 illustrates a system diagram of a trail camera system;

FIG. 2 illustrates a grouping of pictures taken from a trail camera;

FIG. 3 illustrates a sample report from a user interface for a trail camera system;

FIG. 4 illustrates a mapping of potential animal locations;

FIG. 5 illustrates an example of a hunting recommendation output report; and

FIG. 6 illustrates an example of a removable hardware that is connectable to a trail camera.

### SUMMARY

A trail camera system is generally presented. The trail camera system may comprise a camera, such as a digital trail camera, connected to a fixture, such as a tree. The camera may be configured to capture image data of a desired location. The trail camera system may include a database configured to receive image data and an image processor configured to process the image data. The image processor may be located on or at the trail camera or may be located remote from the trail camera and receive the image data through remote communication. The image processor may be configured to compare the image data from the camera with data related to known animals and determine the likelihood of a match between an animal in the image data and a known animal.

In an embodiment, the trail camera system includes a communication module configured to communicate with the database via a remote network. The communication module may be positioned on the trail camera or may be located on a removable hardware that is connected to the trail camera.

In an embodiment, the trail camera system may be configured to only communicate image data that matches predetermined criteria to the database over the remote network. The predetermined criteria may include whether the image data includes an animal that is indigenous to the location of the camera.

In an embodiment, a method of providing predictive animal tracking is provided. The method includes capturing image data from a camera at a known location, wherein the image data includes metadata that includes at least one of a time, a date, a location, and an environmental condition. The method may include processing the image data to determine the existence of an animal within the image data, accessing data related to known animals, comparing the data related to known animals with the image data, and determining the likelihood of a match between the known animal data and the captured image data. The method may further include determining a likelihood of an animal being present at a given location during one or more ranges of time. The likelihood may be based on the processed image data, and further wherein the likelihood is determined based on a consideration of weighted factors including the presence and frequency of an animal at a given location and predicted weather conditions at the given location.

### DETAILED DESCRIPTION

Reference will now be made in detail to exemplary embodiments of the present invention, examples of which are illustrated in the accompanying drawings. It is to be understood that other embodiments may be utilized and structural and functional changes may be made without departing from the respective scope of the invention. Moreover, features of the various embodiments may be combined or altered without departing from the scope of the invention. As such, the following description is presented by way of illustration only and should not limit in any way the various alternatives and modifications that may be made to the illustrated embodiments and still be within the spirit and scope of the invention.

A trail camera system (“TCS”) 10 is generally presented. The TCS 10 is configured to monitor one or more target areas using trail cameras and analyze data returned from the trail cameras to determine the presence, time, and/or location patterns of various animals as well as other information and trends related to the movement and location of the animals.

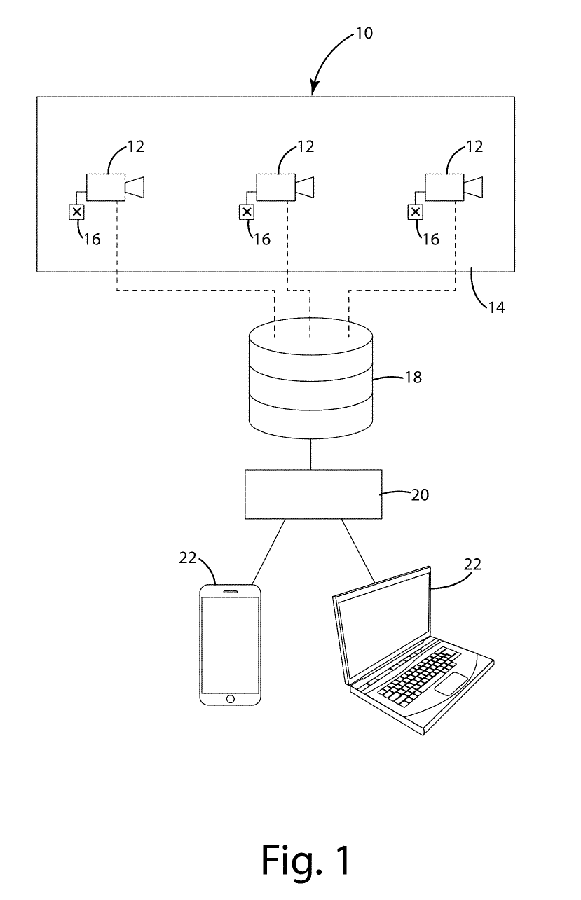

As shown in FIG. 1, the TCS 10 may include a plurality of trail cameras 12. The trail cameras 12 may be placed at desired locations within a known and defined target area 14. The trail cameras 12 may be connected to a fixture within the area 14, such as a tree, tree stand, structure, or the like. Each camera may be oriented and positioned such that the location of the image captured by each trail camera 12 is known and may be used in processing data, as further discussed below.

The trail cameras 12 may be any type of camera, such as a digital camera or camera typically intended for other types of uses, such as security cameras. The trail cameras 12 may be programmed to capture an image of the target area at a given time interval or based on sensing movement or the presence of an object. For example, the TCS 10 may include one or more sensors 16 located near or at a given trail camera 12. The sensor 16 may be any appropriate type of sensor such as a light sensor, movement sensor, heat sensor, or the like. Alternatively, the trail camera 12 may have built in sensing to detect movement or the presence of an object or being. The camera 12 may be configured to capture an image of the target area when an object or being is sensed within the target vicinity.

The TCS 10 may include a database 18. The database may be configured to receive and store image data from the trail cameras 12. The image data may include the digital image data captured by the trail camera 12 as well as related metadata, such as time, date, location, moon phase, environmental conditions, and the like. The image data may be communicated to the database 18 by any appropriate means, such as manually using a digital memory transfer from the cameras 12 to the database 18, or over a network. For example, the trail cameras 12 may be connected to a network, such as a cellular network, Bluetooth network, Wi-Fi network, Zigbee network, LoRaWAN network, or the like. The network may allow for both intercommunication between the trail cameras 12, as well as communication of image data from the trail cameras 12 to the database 18.

The TCS 10 may include an image processor 20. The image processor 20 may comprise any hardware, software, or combination thereof. The image processor 20 may be configured to process image data received from the trail cameras 12 and perform image recognition and object identification to determine the presence of specific species of animals within the image data. The image processor 20 may then append, modify, or amend the data or metadata related to a give image with additional information regarding the recognized animal. That information may include time, date, and location of the animal and categorizing the type of animal, as discussed further below.

The image processor 20 may include proprietary software configured to detect the presence of a given animal in an image, and recognize or determine specific attributes of a given animal that correspond to known attributes. The software may compare an animal in the image data with image data related to known animals. For example, the software may include or have access to image data related to deer. The image processor may compare the image data of an animal from an image captured by a trail camera 12 to known image data related to deer to determine the likelihood of a match. To determine the likelihood of a match, the image processor may use metrics such as the shape of the face, presence of antlers, distance between the eyes, and more may be compared with the known data to determine the likelihood of a match. The resulting likelihood may then be stored in the metadata of the image. The image processor 20 may be capable of determining the following conditions in any image data from the camera 12: presence of a human, presence of an animal, presence of a mammal, presence of birds, species of animal, gender of animal, and whether an animal in image data is the same animal seen in other image data.

In addition to the metrics listed above, various sub-metrics may be used by the image processor to determine the likelihood of a match between a species identified in the image data and a target species. These metrics and sub-metrics may include comparisons of the geometries and positioning of various facial and body features of the target animal with the known data related to the target animal. Examples of such sub-metrics include but are not limited to those provided in the tables below:

For animals with antlers or horns:
Presence of antlers/horn
Distance between antler/horn bases
Distance between antler/horn tips
Count of antler/horn points
Length of antler/horn points
Distance between the eyes
Width of the nose
Depth of the eye sockets
The shape of the cheekbones
The length of the jaw line
Color patterns

For wildlife without horns or antlers:
Distance between the eyes
Width of the nose
Depth of the eye sockets
The shape of the cheekbones
The length of the jaw line
Color patterns

For Fish
Color patterns
Shape of fins
Shape of tail
Shape of jawline (male/female)
Length of jawline (male/female)

For Birds
Color patterns
Presence of beard (Male Turkey)
Presence of Spur
Length of Spur
Presence of crown (Male Peacock)
Shape of beak
Length of beak

For Predators and smaller animals
Presence of tail
Presence of fur on tail
Color patterns

The TCS 10 may include a user interface 22. The user interface 22 may be any appropriate interface, such as a website, software, mobile device application, or the like. The interface 22 may be accessed on any appropriate device, such as a personal computer, laptop, mobile device, or the like. The user interface 22 may provide the user with information and recommendations regarding the location of given types of animals, as set forth in greater detail below. In an embodiment, the user interface 22 may include a website that allows hunters to upload trail camera image data and receive reports and recommendations as described in further detail below.

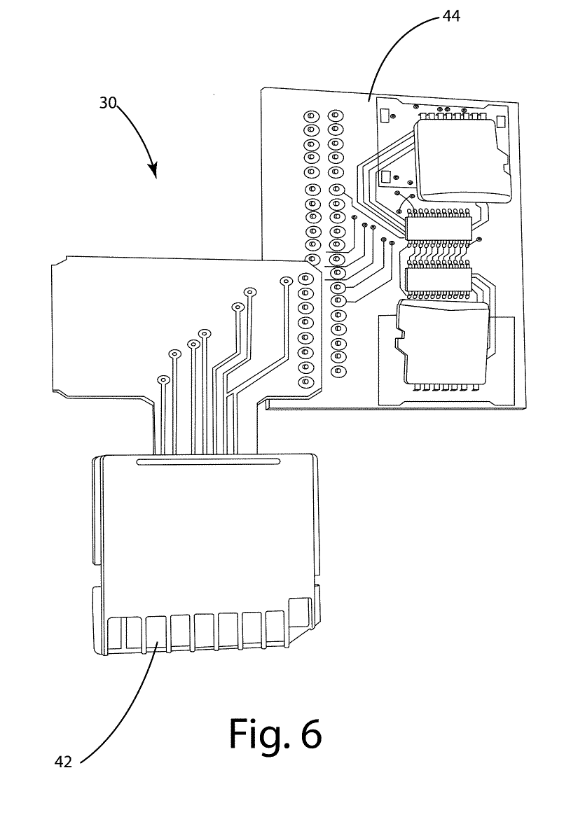

In an embodiment, various components of the TCS 10 may be located on removable hardware 40, as illustrated in FIG. 6. The removable hardware 40 may be connectable with existing cameras 12 to provide retrofit capabilities and convert existing systems into a TCS 10 with the functional capabilities described herein. The removable hardware 40 may be connectable to the camera 12 by any appropriate means to provide a power and communication connection. For example, the removable hardware 40 may be connectable to the camera 12 via USB, HDMI, or any similar connection. In an embodiment, the removable hardware 40 may include a memory card connection 42 and be configured to connect to the camera via a memory card slot located on the camera 12, such as an SD card slot. The SD card connection 42 may power components on the removable hardware 40 and provide communication between the components and the camera 12.

The removable hardware 40 may include any appropriate components, such as a communication module 44 configured to communicate with remote networks described above. The communication module 44 may allow the camera 12 to send data to a remote database 18 to be processed by an image processor.

In an embodiment, the removable hardware 40 may include an image processor 20 on board. The image processor 20 may allow for filtering of images sent to the remote database 18, as described in further detail below.

In an embodiment, the TCS 10 may be configured to allow a user to track a target animal. The target may be a specific category of animal, such as mammals, or a specific type of animal, such as deer, or even a subset of a type of animal, such as a male deer. The user will select the target category, species, or type of species to be tracked, and the image processor 20 will analyze image data to compare the image data with known characteristics of the target. The user interface 22 may then provide the user with recommendations regarding hunting locations and times for finding the target. The recommendations may include maps regarding high probability locations and times, graphs related to peak times when the target may be at given locations, and other metrics to assist in locating the target.

In an embodiment, the image processor 20 may further be capable of searching for and tracking a specific individual animal. For example, the image data uploaded to the database 18 may include an image of a specific animal, such as a mature antlered deer. The image processor 20 may compare the image of the mature antlered deer with other image data to track the target animal. Specifically, images of other animals may be compared with the target animal image by comparing features such as the presence of antlers/horn, the distance between antler/horn bases, the distance between antler/horn tips, the number of antler/horn points, the length of antler/horn points, the distance between the eyes, the width of the nose, the depth of the eye sockets, the shape of the cheekbones, the length of the jaw line, and/or color patterns. Based on the results of the comparison, the image processor 20 may assign the likelihood of a match between a given animal and the target animal. The user interface 22 may then provide tracking information to the user, such as locations and times where the target animal will likely be found. In an embodiment, the user interface 22 may provide a travel route of an animal when image recognition matches the same animal traveling between two cameras with time stamps.

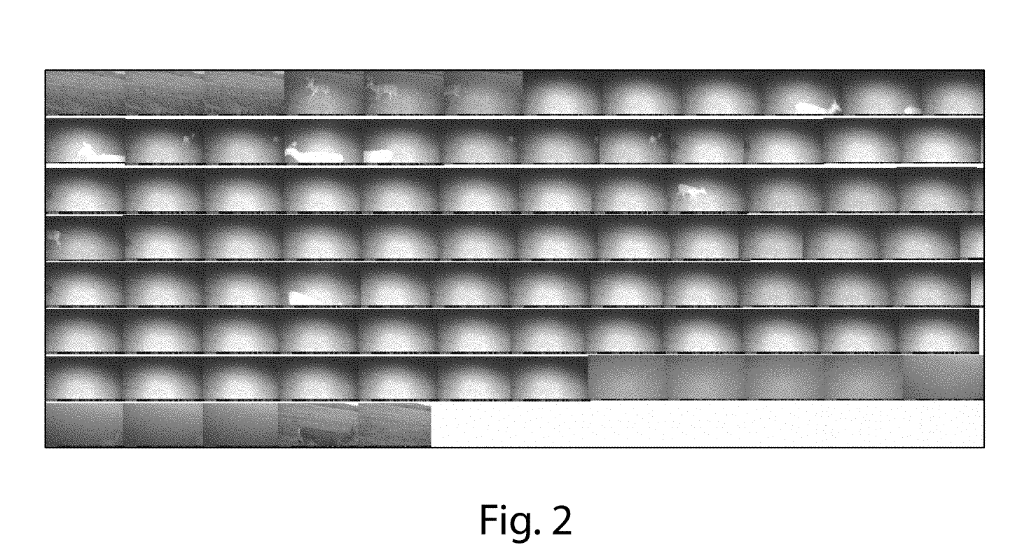

In an embodiment, the trail cameras 12 may be configured to include an image processor 20 or image processing capabilities on board or on site with the cameras 12. The image processor 20 may sort through images as they are captured by the camera to filter out images that do not contain useful information. For example, a trail camera 12 may be configured to capture an image when movement and heat are both detected. However, in certain instances, the captured image may be falsely triggered by movements and temperature changes that are not caused by animals. For example, as illustrated in FIG. 2, in a grouping of images captured by a trail camera 12, only a small percentage of the images may actually contain images of animals and useful data. The on board image processor 20 may therefore be configured to filter out any images that do not contain an animal, thereby reducing the amount of data to be transferred from the trail camera 12 to the database 18. Further, the on board image processor 20 may be selectively configured to filter out all animals other than a specific category or species of animal, thus further reducing the amount of data to be transferred from the trail cameras 12 to the database 18.

The on board image processor 20 may further be configured to filter out any potential matches that are not native to the location of the trail camera 12. For example, a trail camera 12 located in Alaska may be configured to omit possible selections of animals, such as lion, that are not indigenous to Alaska, thus narrowing the pool of available matching animals and increasing the odds of an accurate match by the image processor. The image processor 20 may have access to data that provides subsets of potential species that are indigenous to given areas. The image processor 20 may further have access to information that provides the location of the camera 12 to determine which subset of indigenous species are appropriate for that camera location. Alternatively, the image processor 20 may be directly programmed, such as through a user interface 22, to filter out specific animals or subsets of animals or only report specific animals or subsets of animals.

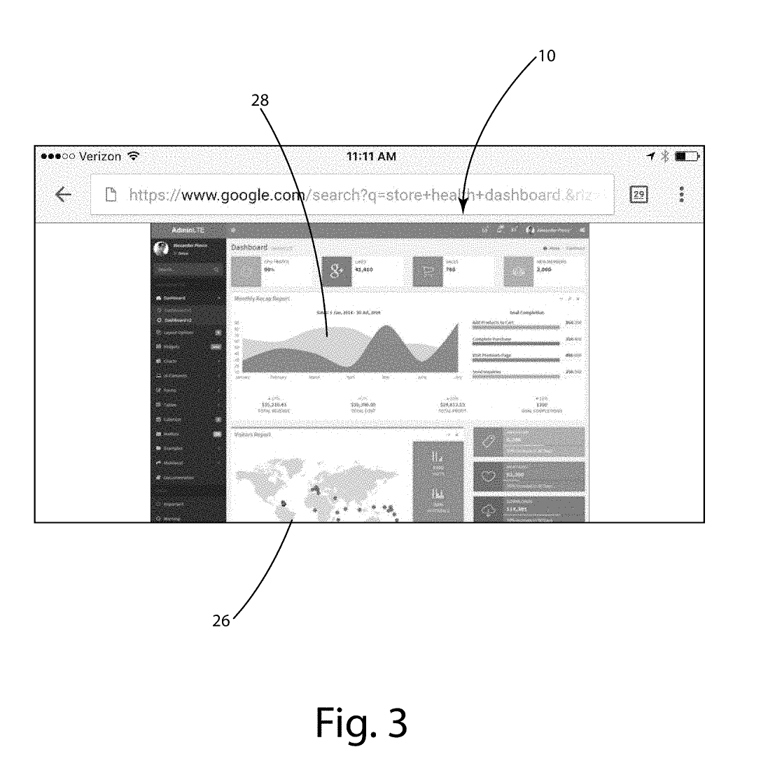

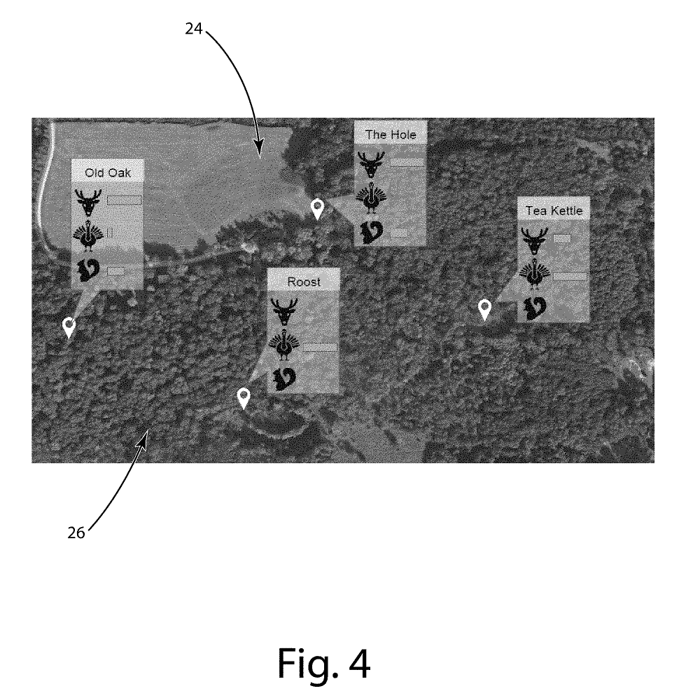

The user interface 22 may be configured to provide various reports 24 to the user, as shown in FIG. 3. The reports 24 may include feedback and recommendations based on the desired criteria entered by the user for evaluating the trail camera information. For example, for a user seeking to track a specific species of animal, the user interface 22 may generate a report 24 that includes a map 26. The map 26 may include the locations of each trail camera 12 along with the frequency and times when the target species was at each trail camera location. As shown in FIG. 4, a map 26 may further display the defined target area 14 and list one or more species and the frequency at which the species appeared at each trail camera location. For each trail camera 12, the user interface may generate a report 24 that provides a time graph 28 illustrating frequency of how often the target species was at the trail camera location. The reports may further include frequency and location information for other species or for a specific target animal within a target species.

In an embodiment, the TCS 10 may provide alerts to a user when an animal or target animal or human is detected at a given location, such as at a trail camera location. For example, the trail camera 12 may capture image data and the image processor 20 may process the image data to determine the existence of a target animal identified by a user. The TCS 10 may send an alert to the user to alert them of the presence of the target animal at the location. The alert may comprise a text message to a cellular phone, an email, or any other type of communicable alert.

In an embodiment, the TCS 10 may be configured to monitor the movement of a specific animal, or of animal populations. By using the location of each trail cameras 12 within the target area as well as the time and location metadata from each image, the image processor 20 may track the movement of an individual animal or group of animals from one monitored location to another. The TCS 10 may also consider other external factors such as predicted weather, wind direction, historical movement patterns, and the like, to predict the movement and location of animals and herds. The image processor 20 may use specific facial recognition to verify that the group of animals captured on images at a first camera 12 are the same group of animals captured on images at a second camera 12 by matching one or more animals in the group from the first camera images with one or more animals in the group from the second camera images.

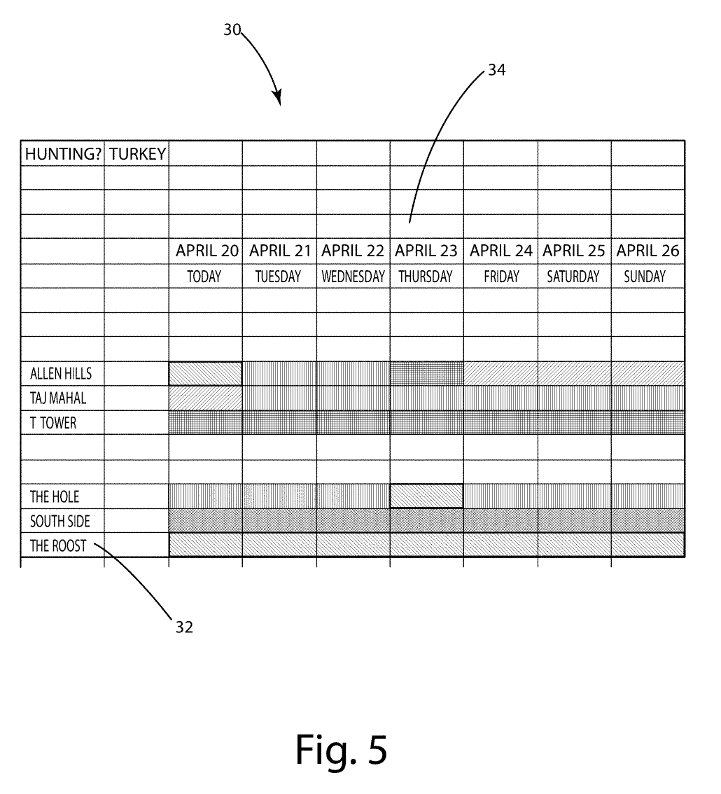

In an embodiment, the TCS 10 may provide recommendations for locating and hunting given animals at specified locations, such as trail camera locations. An example of a hunting recommendation output 30 is illustrated in FIG. 5, however, it will be appreciated that the output information described herein may be provided in any appropriate format. The recommendation output 30 may comprise a chart or table that lists one or more locations 32, such as locations of trail cameras 12, and provides a range of times 34. As illustrated, the chart may provide predictions of the likelihood of an animal being present at given times or time ranges for each listed location. While the output shows the predictions at trail camera locations, it will be appreciated that locations may be predicted in areas other than trail camera locations as well.

The hunting recommendation output 30 may utilize gathered data, including image data from trail cameras 12 and the image processor 20 as described above, to determine optimal times and locations for hunting a desired animal. The data considered when determining recommended times and locations for hunting may include: 1) the presence of an identified animal at a given location; 2) frequency of an identified animal at a given location (such as at a minimum of 15 minutes apart) 3) the presence of an identified animal during daylight hours at a given location; 4) predicted weather conditions based on local weather information at a given location, where weather conditions may include temperature, wind speed, wind direction, air pressure, moon phase, visibility, cloudiness, and the like; and 5) historical weather patterns including temperature, wind speed, wind direction, air pressure, moon phase, visibility, cloudiness, and the like. It will be appreciated that other data and input information may be considered as well when determining hunting location recommendations.

In an embodiment, the hunting location recommendation output 30 may be determined using an algorithm. The algorithm may evaluate any of the criteria discussed above and assign a rank or score to each criteria considered. For example, the algorithm may assign a point value to a location based on wind speeds or expected wind speeds whereby a higher score is assigned for lower wind speeds. The algorithm may further assign higher points for given ranges of temperature, air pressure, and the like as well. For example, the algorithm may assign greater points when the temperature is closer to normal temperatures for a region or time period and fewer points when the temperatures vary more greatly from normal temperatures. Likewise, the algorithm may assign higher points for wind speeds that are closer to normal wind speeds and fewer points for wind speeds that vary more greatly from normal wind speeds for a given area. The likelihood of an animal matching the tracked animal appearing at the given location may then be calculated by compiling the individual scores or rankings.

It will be appreciated that the image recognition capabilities of the TCS 10 may have usefulness outside of the trail camera setting. To that end, and without departing from the nature of the invention, various embodiments, such as those described below, may incorporate image recognition aspects of the TCS 10 for use in other fields.

In an embodiment, the database 18 and image processor 20 may be used to analyze medical imaging data. For example, medical images such as MRI scans, x-rays, CAT scans, or the like may be stored on the database 18. The image processor 20 may be configured to scan the medical images and compare the image data with known conditions. For example, the image processor 20 may be configured to search MRI image data to locate scans that include data similar to known cancers. Images may then be assigned a rating based on the likelihood of a match to the known cancer. In an embodiment, pre-screening patient images may be loaded onto the database for pre-screening analysis. The pre-screening images may include images of skin conditions and the like and compared with known imaging data related to other skin afflictions. Patients may then be routed to appropriate medical personnel based on the likelihood of a match between the pre-screening image and the potential condition.

In an embodiment, the database 18 and image processor 20 may be used to analyze agricultural imaging data. For example, digital images of landscapes or crops may be loaded into the database 18. The image processor 20 may analyze the agricultural images to determine crop damage, water shortage, or other potential environmental concerns. In addition, images of cattle may be loaded into the database and analyzed by the image processor 20 to determine if they are receiving proper nutrition.

In an embodiment, the database 18 and image processor 20 may be used to analyze structural imaging data. During construction, buildings and structures often are required to pass rigorous inspections to meet code standards. In order for builders to confirm that their buildings are being constructed to code, digital images may be taken of targeted areas of the structure, including foundations, wiring, duct work, insulation, welds and other joints, support beams, and the like. The digital images may be loaded into the database 18 and analyzed by the image processor 20 to compare with image data related to known code standards. The image processor 20 may then assign a likelihood of a code violation to provide the builder with notice of potential issues.

In an embodiment, the database 18 and image processor 20 may be used to analyze traffic imaging data. For example, cameras may be strategically positioned to capture images of traffic flow along targeted roads and highways. The traffic flow images may be fed to the database 18 in real time and processed by the image processor 20 to determine the location of accidents, flow restrictions, and other traffic obstructions. The image processor 20 may provide recommendations for easing traffic flow restrictions that may be then used in real time by traffic lights and the like. In an embodiment, the traffic cameras may capture pictures of vehicles as they pass by targeted locations. The traffic imaging data may then be analyzed and compared with image data for known types of vehicles to determine the type of vehicles on the road, including the make, model, year, and color of each vehicle driving at the target location.

Although the embodiments of the present invention have been illustrated in the accompanying drawings and described in the foregoing detailed description, it is to be understood that the present invention is not to be limited to just the embodiments disclosed, but that the invention described herein is capable of numerous rearrangements, modifications and substitutions without departing from the scope of the claims hereafter. The claims as follows are intended to include all modifications and alterations insofar as they come within the scope of the claims or the equivalent thereof.

Having thus described the invention, we claim:

1. A trail camera system comprising:
a camera connected to a fixture, wherein the camera is configured to capture image data of a desired location, and wherein the image data includes an image of an animal;
a database configured to receive image data from the camera; and
an image processor configured to process image data and compare the image data from the camera with data related to known animals and determine the likelihood of a match between an animal in the image data and a known animal.

2. The trail camera system of claim 1, wherein the likelihood of a match is determined by comparing geometric features of an animal in the image data with known data related to geometric features of similar animals.

3. The trail camera system of claim 1 further comprising a user interface connected to the trail camera system, wherein the user interface is configured to receive input data from a user.

4. The trail camera system of claim 3, wherein the known animal comprises a subset of animals or a single animal input by a user into the system via the user interface.

5. The trail camera system of claim 1, further comprising a communication module configured to communicate with the database via a remote network.

6. The trail camera system of claim 5, wherein the communication module is configured to communicate over at least one of a cellular network, Bluetooth network, Wi-Fi network, Zigbee network, and LoRaWAN network.

7. The trail camera system of claim 5, wherein the communication module is located on a removable hardware.

8. The trail camera system of claim 7, wherein the removable hardware is connected to a memory card slot on the camera.

9. The trail camera system of claim 7, wherein the image processor is located on the removable hardware.

10. The trail camera of claim 5, wherein the system is configured to only communicate image data that matches predetermined criteria to the database over the remote network.

11. The trail camera system of claim 10, wherein the predetermined criteria includes whether the image data includes an animal that is indigenous to the location of the camera.

12. The trail camera system of claim 1, wherein the trail camera system is configured to provide an alert to a user when a match between an animal in the image data and a known animal is found.

13. The trail camera system of claim 1, wherein the alert is sent over a cellular network.

14. A method of providing predictive animal tracking comprising:
capturing image data from a camera at a known location, wherein the image data includes metadata that includes at least one of a time, a date, a location, and an environmental condition;
processing the image data to determine the existence of an animal within the image data, wherein processing the image data includes accessing data related to known animals, comparing the data related to known animals with the image data, and determining the likelihood of a match between the known animal data and the captured image data; and
determining a likelihood of an animal being present at a given location during one or more ranges of time, wherein the likelihood is based on the processed image data, and further wherein the likelihood is determined based on a consideration of weighted factors including the presence and frequency of an animal at a given location and predicted weather conditions at the given location.

15. The method of claim 14 further comprising the step of providing a summary based on the determined optimal hunting location, wherein the summary includes a scoring of optimal hunting times for one or more locations.

16. The method of claim 14, wherein processing the image data to determine the existence of an animal includes determining the existence of a specific animal within the image data.

17. The method of claim 16, wherein the summary provides hunting location recommendations for specified animals.

18. The method of claim 14, wherein the predicted weather condition includes at least one of a temperature, a wind speed, a wind direction, and an air pressure.

19. The method of claim 14, wherein the determined likelihood is further based on data related to historic weather patterns for a given location.

20. The method of claim 14, wherein the determined likelihood is further based on the frequency or presence of an animal at a given location during daylight hours.
